(19) United States
(12) Patent Application Publication
(10) Pub. No.: US 2007/0019407 A1
(43) Pub. Date: Jan. 25, 2007

(54) Two dimensional optical scanning apparatus and image display apparatus using the same

(76) Inventor: Tae-Sun Song, Seoul (KR)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/575,926

(22) PCT Filed: Oct. 14, 2004
(86) PCT No.: PCT/KR04/02629

§ 371 Date: Apr. 14, 2006

(51) Int. Cl. F21S 4/00

(52) U.S. Cl. 362/225

(57) ABSTRACT

A two-dimensional optical scanning apparatus has a rotating body or a moving body that rotates endlessly. The apparatus has at least two linear light source units. The rotating body may be formed in a shape of a cylindrical drum. The moving body may have at least two cylindrical drums and an endless belt connected between the drums. Each linear light source unit is displaced on the rotating body or moving body to alternately project images with each other. The apparatus projects light in several directions so it is used in an image display apparatus with a plurality of screens.

### BACKGROUND OF THE INVENTION

(a) Field of the Invention

The present invention relates to a two-dimensional optical scanning apparatus and an image display apparatus using the same, and more particularly to a two-dimensional optical scanning apparatus and an image display apparatus using the same in which a linear light source rotates or moves to scan a light beam two-dimensionally.

(b) Description of the Related Art

Recently, wide-screen image display apparatuses have been popular. It is possible to classify the wide-screen image display apparatuses as a direct view type such as a CRT device, a projection type such as an LCD device, and an optical scanning type.

The CRT device of the direct view type produces color images when its phosphorescent surface is struck by red/green/blue electron beams. The CRT device is required to have a large traveling distance of electron beams between electron guns and the phosphorescent surface, resulting in huge dimensions and a heavy weight thereof. Therefore, the CRT device is not suitable for a wide-screen image display apparatus.

The LCD projector of the projection type has an advantage of a slim size, but it has a drawback in that it is required to employ a polarizer which may incur light loss.

An image display apparatus of the optical scanning type has been suggested in Korean Patent No. 0366155, granted to the applicant of the present invention. Since two rotatory polygon mirrors are employed to two-dimensionally scan light in the above patent, the entire optical scanning apparatus has relatively large dimensions. Since the reflecting surfaces of the two rotatory polygon mirrors rotate around their rotating axes, they shift to deviate with respect to optic axes. Further, the apparatus has drawbacks in that it requires a polygon mirror with a large mirror surface in the case that a ray with a large incident angle enters into the polygon mirror.

### SUMMARY OF THE INVENTION

In view of the prior art described above, it is an object of the present invention is to provide a two-dimensional optical scanning apparatus and an image display apparatus using the same in which a linear light source itself rotates or moves to scan light two-dimensionally without any polygon mirror.

It is another object of the present invention to provide an image display apparatus using an optical scanning apparatus to display images on a plurality of screens.

To achieve these and other objects, a two-dimensional optical scanning apparatus according to a first aspect of the present invention has a rotating body, and at least two linear light source units disposed on a surface of the rotating body. Each linear light source is comprised of a plurality of lighting elements that are arranged in a row to emit red, green, and blue light that are modulated according to an image to be displayed. The rotating body is in the shape of a cylindrical drum.

According to a second aspect of the present invention, a two-dimensional optical scanning apparatus has a moving body that rotates endlessly, and at least two linear light source units disposed on the moving body. Each light source is comprised of a plurality of lighting elements that are arranged in a row to emit red, green, and blue light that are modulated according to an image to be displayed. The moving body has at least two cylindrical drums, and an endless belt or chain that is connected between the drums.

According to a third aspect of the present invention, an image display apparatus has a rotating body, at least two linear light sources units disposed on a surface of the rotating body, and at least one screen on which a scanned light beam is projected.

According to a third aspect of the present invention, an image display apparatus has a moving body that rotates endlessly, at least two linear light sources units disposed on the moving body, and at least one screen on which a scanned light beam is projected.

When the two or more screens are employed, each screen is arranged in a different direction from each other.

### BRIEF DESCRIPTION OF THE DRAWINGS

FIGS. 1 and 2 show a schematic perspective view and a side view of a two-dimensional optical scanning apparatus according to a first embodiment of the present invention;

FIG. 3 shows a view illustrating a linear light source unit;

FIG. 4 shows a view illustrating a collimator lens;

FIG. 5 shows a view illustrating a wedged prism;

FIG. 6 shows another example of the first embodiment;

FIG. 7 shows a schematic side view of a two-dimensional optical scanning apparatus according to a second embodiment of the present invention;

FIG. 8 shows another example of the second embodiment;

FIG. 9 shows a view illustrating a change of scanning time of the two-dimensional optical scanning apparatus according to the first embodiment; and

FIG. 10 shows another example of an image display apparatus using an optical fiber bundle with a screen.

### DETAILED DESCRIPTION OF THE PREFERRED EMBODIMENTS

Preferred embodiments of the present invention will hereinafter be described in detail with reference to the accompanying drawings, wherein like numerals of reference designate like elements throughout.

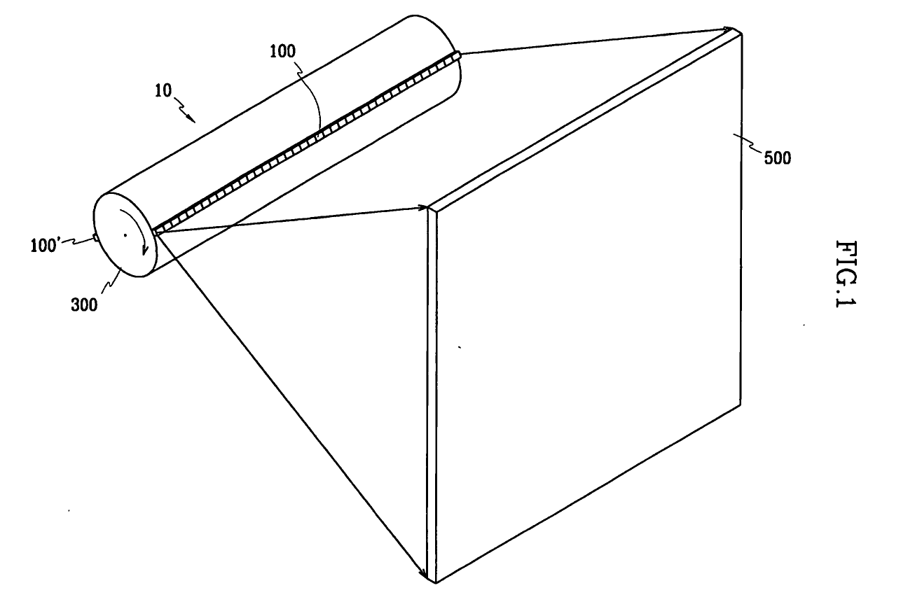

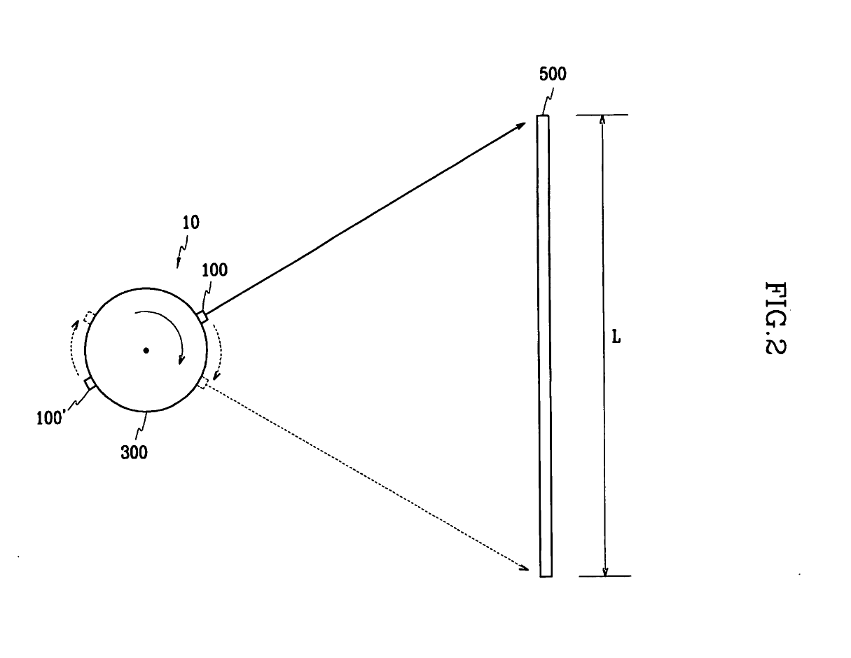

Referring first to FIGS. 1 and 2, a two-dimensional optical scanning apparatus 10 according to a first embodiment of the present invention has a cylindrical drum 300 that is rotated by a motor (not shown), and two linear light source units (a first linear light source unit 100 and a second linear light source unit 100′) displaced on a cylindrical surface of the drum 300.

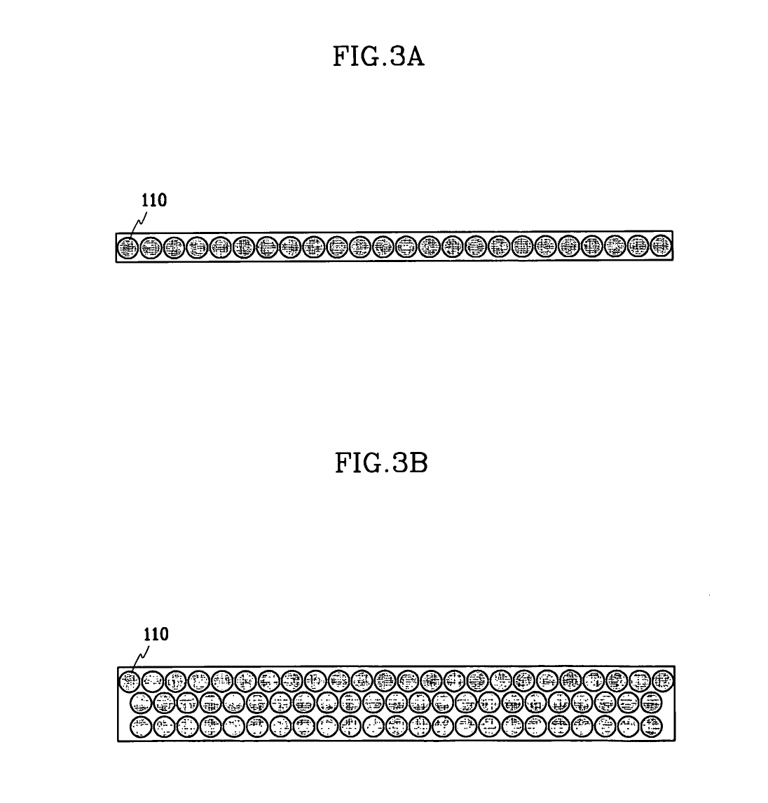

Each linear light source unit 100, 100′ preferably has a plurality of lighting elements 110, such as laser diodes or light emitting diodes (LEDs), which are arranged in a row to emit red, green, and blue light that are modulated according to an image to be displayed. The linear light source unit 100 may have lighting elements 110 in a row as shown in FIG. 3a. It may also have an array of two or more rows of a plurality of lighting elements for high resolution power or high brightness, as shown in FIG. 3b.

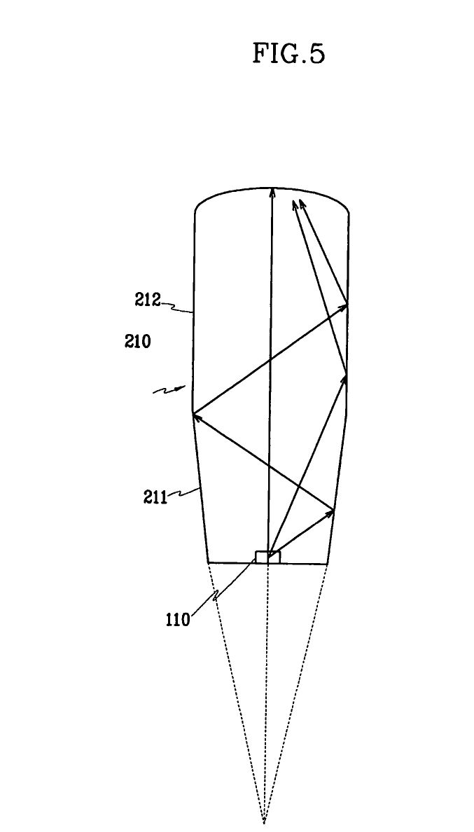

In order to maximize the intensity efficiency of the light emitted from each light emitting device, a wedge prism 210 or wedged reflecting surface may be employed, as shown in FIG. 5. The wedge prism 210 has a tilted reflecting surface 211, a total reflecting surface 212 parallel with the optic axis, and a lens surface 213. When the lens surface 213 can collimate light, a separate collimator lens unit 200 may be omitted. The light emitted from each light emitting device 110 reflects from the tilted reflecting surface 211, and then internally reflects from the total reflecting surface 212 a plurality of times to decrease a diverging angle of each reflection to enhance efficiency of light.

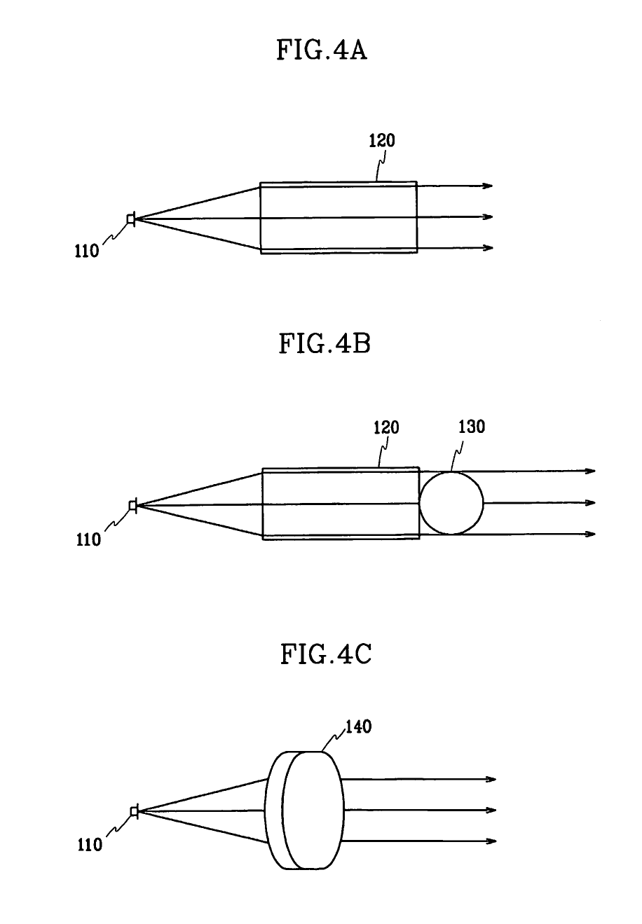

Each lighting element 110 of the linear light source may have a collimator lens which may convert light from the element 110 into a collimated light beam. The collimator lens may be an array of a small rod lens 120 and/or a ball lens 130, or an aspherical lens 140, which are shown in FIGS. 4A-4C. It is possible to employ either of these lens types as shown in FIGS. 4A-4C with a cylindrical lens (or toric lens).

Each lighting element may be constructed by forming an epoxy cast lens surface on an LED chip for converting light into converging, diverging, or collimated light beams. The lens surface may be a spherical or aspherical surface, including a Cartesian Oval surface.

The lighting elements may be surface emitter type LEDs. When the surface emitter type LEDs are employed, it is preferable to coat a metal film on the surfaces of the LEDs except at the emitting surface to reflect light internally by the metal film and to limit the emitting region. Since a surface emitter type LED emits light from the sides as well as the surface of the active layer thereof, it is difficult to convert the emitting light into a useful collimated beam or converging beam as well as to obtain high light efficiency when an external optical element is used. Accordingly, the entire optical system of the apparatus can be made simple with an enhanced optical quality to define the emitting region by the metal film.

Although FIGS. 1 ad 2 show two linear light source units 100 and 100′, it is possible to provide a plurality of light source units according to the desired design. When the number of the linear light source unit is n, each light source unit is disposed at an angle of 360° /n with respect to an adjacent unit around a rotating axis of the drum. The linear light source units 100 and 100′ are disposed parallel with the rotating axis of the drum.

The two dimensional optical scanning apparatus according to the first embodiment of the present invention operates as follows.

When the rotating drum 300 begins to rotate, the first and second linear light source units 100, 100′ rotate on the rotating cylindrical drum 300. When the first linear light source unit 100 first faces toward the screen 500, light emitted from the first linear light source unit 100 is scanned onto the screen 500. Then, light emitted from the second linear light source unit 100′ is scanned onto the screen 500 when the second linear light source unit 200 faces toward the screen 500. Accordingly, the first and second linear light source units 100 and 100′ rotate and alternate with each other to project images.

Although it is not shown in the drawings, a suitable optical element may be displaced between the linear light source unit 100 and the screen 500 to compensate for aberrations in order to enhance image quality or to adjust magnification of the screen, such as enlargement and reduction.

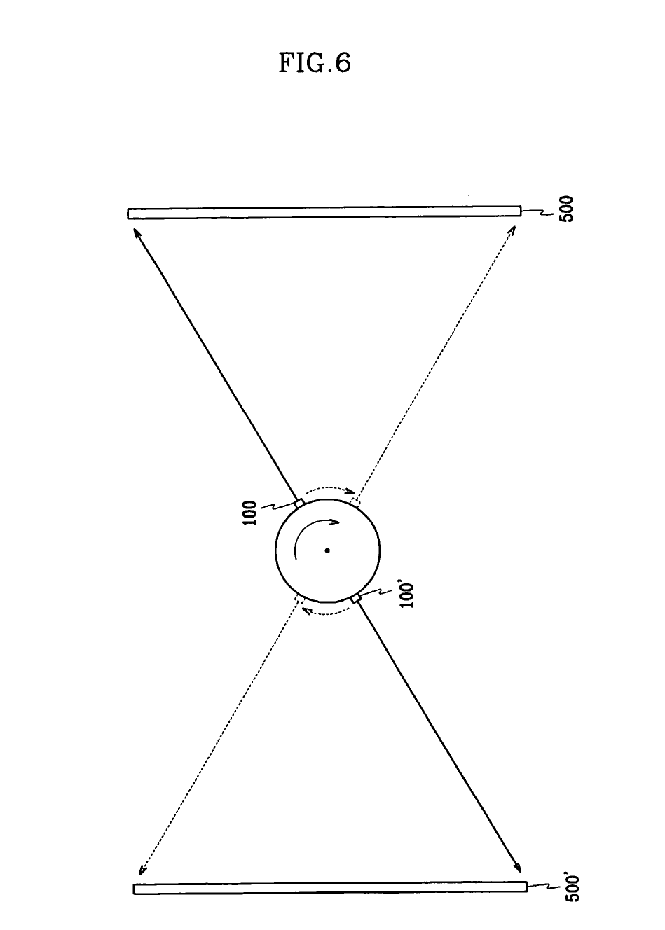

An image display apparatus using the two-dimensional optical scanning apparatus 10 has a screen 500 as shown in FIGS. 1 and 2. It is also possible to use two screens 500 and 500′ as shown in FIG. 6. The image display apparatus may be designed for varying the number of screens and arrangement thereof in accordance with a desired purpose. It should be noted that each screen can display a different image. It is possible to provide two or more light source units according to the desired design.

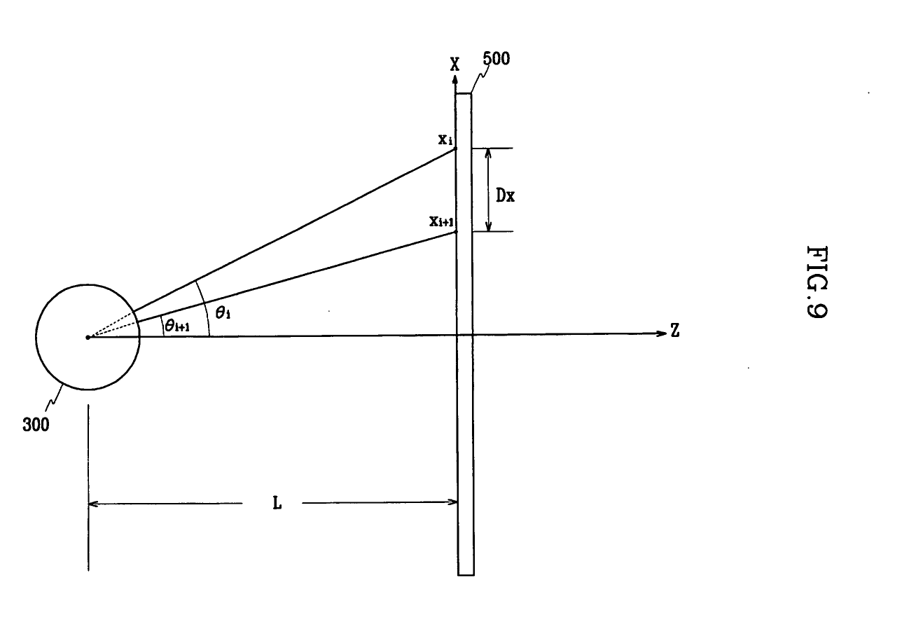

When the linear light source unit 100 is mounted on the rotating body 300 to scan light at a constant angular velocity, image quality and resolution power are changed according to the distance from the optical axis on the plane screen 500. An emitting time of the linear light source unit may be changed according to a scanning angle in order to obtain a uniform image quality on the screen 500. Referring to FIG. 9, the emitting time depending on the scanning angle will be described.

First, let us assume that the optical axis of the scanning unit is a z-axis and that the screen 500 lies parallel to an x-axis, as shown in FIG. 3. An average pixel size Dx of the screen is defined as follows:
Dx=L tanθₘₐₓ /k, (1)
where L is a scanning distance, θₘₐₓ is a maximum scanning angle, and (2k+1) is a maximum line number of the pixels.

When θᵢ and θᵢ₊₁ are scanning angles of the i-th line and (i+1)-th line, respectively, the light reflected by the scanning unit 300 is scanned on a point xᵢ on the screen, and then a point xᵢ₊₁ in the next line. The difference xᵢ−xᵢ₊₁ between the two points should be the average pixel size Dx in order to maintain a uniform resolution power. Since the pixel size Dx at any point on the screen should be constant all over the screen, it is defined as follows:
xᵢ−xᵢ₊₁=L (tanθᵢ−tanθᵢ₊₁) =Dx. (2)

Therefore, condition (3) may be obtained from conditions (1) and (2):
tanθₘₐₓ/k =(tanθᵢ−tanθᵢ₊₁). (3)

When the rotatory polygon mirror rotates at a constant angular velocity ω with respect to the light source which is fixed, the scanning time interval Δt between the i-th line and (i+1)-th line is defined by the following condition (4):
Δt=(θᵢ−θᵢ₊₁)/2 ω. (4)

Accordingly, the scanning time interval Δt between the i-th line and (i+1)-th line may be obtained from conditions (3) and (4). The light emitted from the linear light source 100 is scanned two-dimensionally by the rotation of the rotating body 300 to display an image on the screen. Further, the emitting time may be changed according to the conditions (3) and (4) for each scanning angle to obtain a uniform pixel size Dx on the screen 500. Therefore, image quality and resolution power are uniform all over the screen.

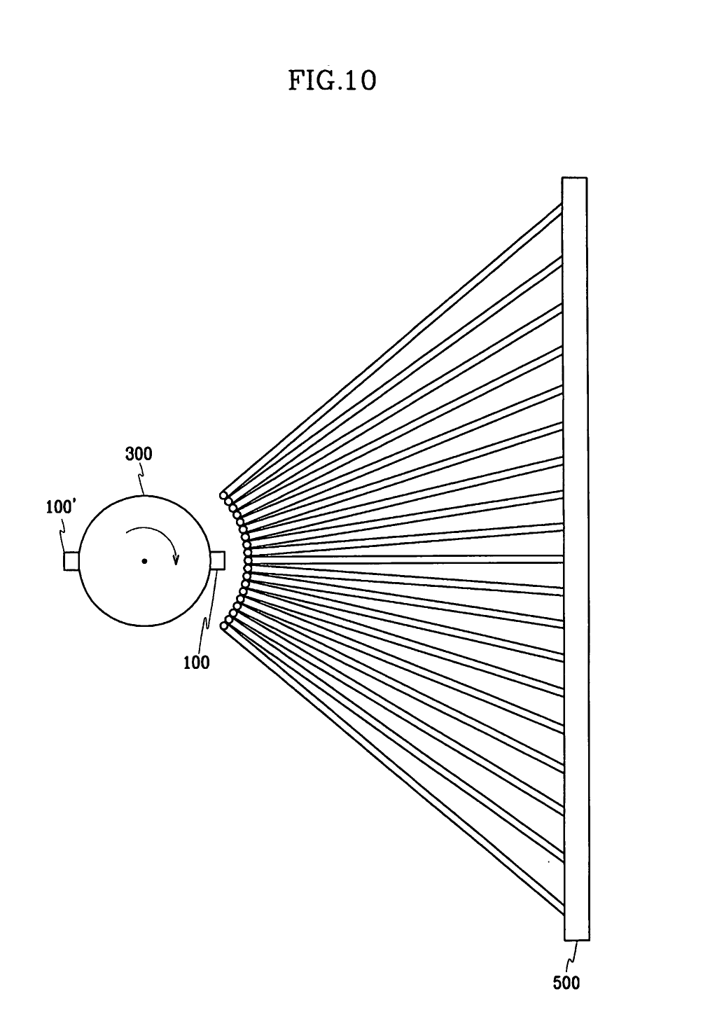

In addition to the change of the emitting time, it is possible to use a prism block for compensating deviations of pixel size in order to obtain a uniform image quality and resolution power. As shown in FIG. 10, a bundle of optical fibers may be placed on the screen 500 to obtain a uniform image quality and resolution power.

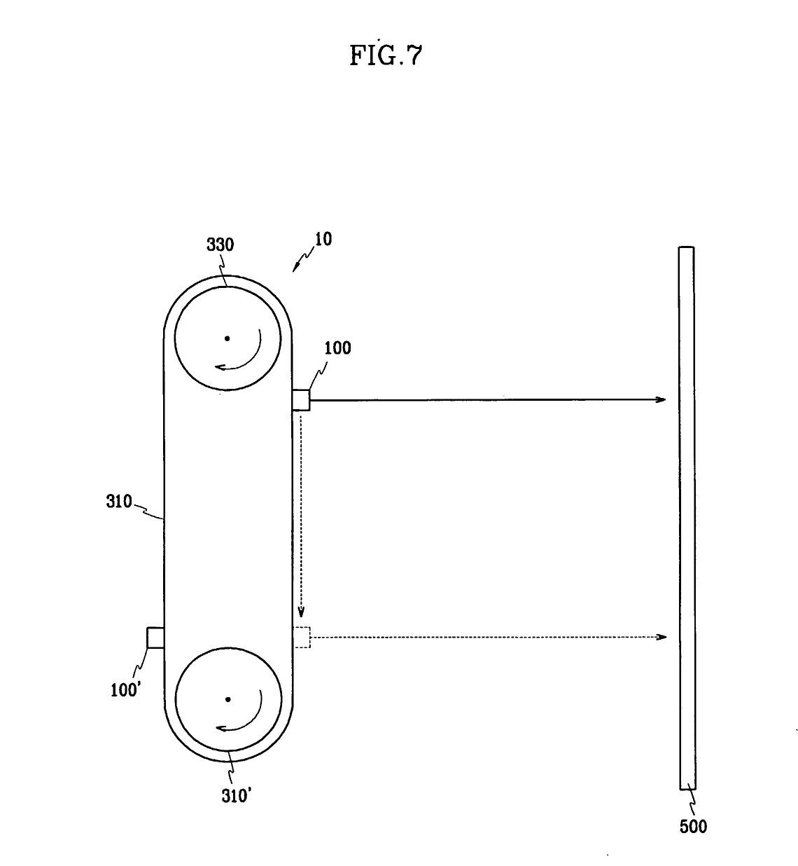

Referring next to FIG. 7, a two-dimensional optical scanning apparatus 10 according to a second embodiment of the present invention has first and second cylindrical drums 310 and 310′, each of which is rotated by a motor (not shown), and an endless belt 330 that is connected between the drums 310, 310′. The apparatus has two linear light source units (a first linear light source unit 100 and a second linear light source unit 100′) displaced on the endless belt 330. Although the belt 330 is connected between the two drums 310 and 310′ in the drawing, it is possible to connect the two drums using an endless chain, etc. It is also possible to using a linear motor to move the linear light source units.

Each linear light source unit 100, 100′ preferably has a plurality of lighting elements such as laser diodes or light emitting diodes (LEDs), which are arranged in a row to emit red, green, and blue light that are modulated according to an image to be displayed. It is possible to implement various kinds of linear light source units as explained above, referring to FIGS. 3 to 5 with respect to the first embodiment.

Although FIG. 7 shows two linear light source units 100 and 100′, it is possible to provide a plurality of light source units of more than two according to the desired design. When the number of linear light source units is n and the length of the belt 330 is s, each light source unit is disposed at a distance interval s/n with respect to an adjacent unit on the belt 330. The linear light source units 100 and 100′ are disposed parallel with the rotating axes of the drums 310, 310′.

FIG. 7 shows two drums 310 and 310′, but the number is not limited by the drawing. It is possible to provide a plurality of cylindrical drums of more than two according to the desired design.

The two dimensional optical scanning apparatus according to the second embodiment of the present invention operates as follows.

The belt 330 is connected between the two drums 310, 310′, which rotate at the identical angular velocity, and is circulated endlessly. The first and second linear light source units 100, 100′ are disposed on the belt 330 to rotate in accordance with the circulation of the belt 330. When the first linear light source unit 100 first faces toward the screen 500, light emitted from the first linear light source unit 100 is scanned onto the screen 500. Then, light emitted from the second linear light source unit 100′ is scanned onto the screen 500 when the second linear light source unit 200 faces toward the screen 500. Accordingly, the first and second linear light source units 100 and 100′ rotate and alternate to project images with each other.

When the drums rotate at a constant angular velocity, the belt 330 moves at a constant velocity in terms of its linear motion. The linear velocity is L×m per second where a length of the screen in a scanning direction is “L,” and the number of image frames per second is “m”. Further, when a radius of the drum 300 is “r ” and an angular velocity of the drum is “ω”, the linear velocity v is as follows:
v=ω×r=L×m.

When the angular velocity ω of the drum is constant, the linear velocity v is also constant to maintain a uniform scanning time. When the apparatus uses a section for linear motion, it is possible to employ a linear motor instead of a belt and drums.

Although it is not shown in the drawings, a suitable optical element may be displaced between the linear light source unit 100 and the screen 500 to compensate for aberrations in order to enhance image quality or to adjust magnification of the screen such as enlargement and reduction.

An image display apparatus using the two-dimensional optical scanning apparatus 10 according to the second embodiment has a screen 500 as shown in

FIG. 7. It is also possible to design two or more screens for a desired purpose.

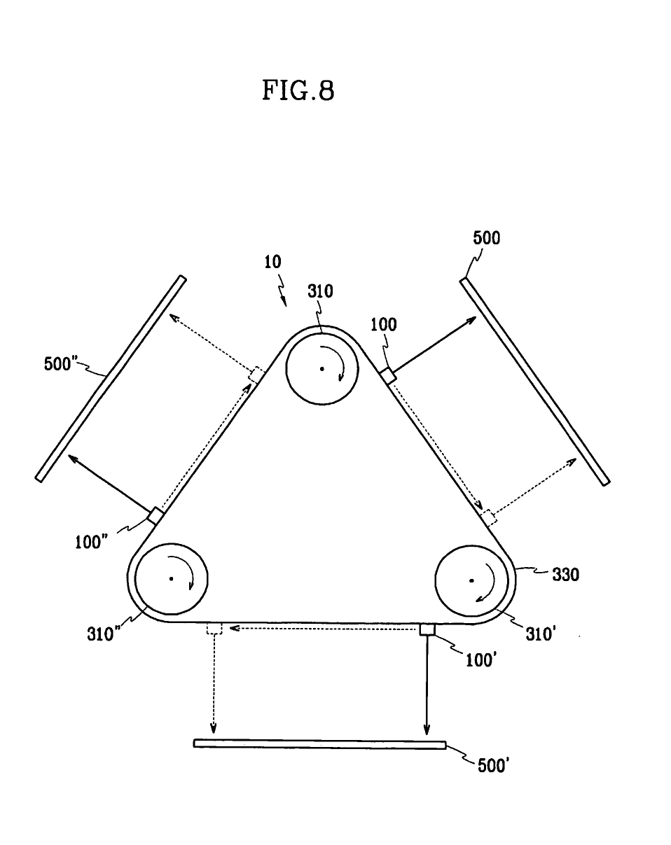

FIG. 8 shows an image display apparatus using three screens. The image display apparatus has a two-dimensional optical scanning apparatus 10 having three cylindrical drums 310, 310′, and 310″ and an endless belt 330 that is connected between the drums. A plurality of linear light source units 100, 100′, and 100″ may be displaced on the endless belt 330. FIG. 8 shows three linear light source units 100, 100′, and 100″ and three screens 500, 500′, and 500″. The image display apparatus may be designed for varying the number of screens, types (transmission type or reflection type), and arrangement thereof in accordance with a desired purpose. It should be noted that each screen can be provided with a different image.

Furthermore, the linear light source units are either in linear motion or rotating motion in the two-dimensional apparatus according to the second embodiment. Therefore, it can be adjusted that the linear light source unit emits light in its linear motion only or in its rotating motion only, resulting in various kinds of scanning effects.

As described above, the two-dimensional optical scanning apparatus has an advantage in that it has a smaller size than that of the conventional one since it uses a rotating body or a moving body that rotates endlessly, and since the apparatus does not employ a polygon mirror to avoid the optical aberration including distortion due to the polygon mirror. Further, it is possible to avoid the design difficulty that results from a polygon mirror of off-axis deviations.

Furthermore, it is possible to construct various kinds of light sources according to the present invention. The present invention may be applicable to a large-screen image display since the apparatus can scan light in a magnified image.

The image display apparatus having two or more optical scanning apparatus according to the present invention may display a composite image to be applied to various kinds of uses with various display effects.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims. Specifically, it should be noted that a rotating body or a moving body on which linear light source unit is mounted can be modified in various ways in addition to the body described in the first and second embodiments of the present invention.

1. A two-dimensional optical scanning apparatus comprising: a rotating body; and
at least two linear light sources units disposed on a surface of the rotating body, comprising a plurality of lighting elements that are arranged in a row to emit red, green, and blue light that are modulated according to an image to be displayed.

2. The two-dimensional optical scanning apparatus as recited in claim 1, wherein the rotating body is in a shape of a cylindrical drum.

3. The two-dimensional optical scanning apparatus as recited in claim 2, wherein when the number of linear light source units is n, each linear light source unit is disposed at an angle of 360° /n with respect to an adjacent unit on the surface of the rotating body.

4. A two-dimensional optical scanning apparatus comprising:
a moving body that rotates endlessly; and
at least two linear light sources units disposed on the moving body, comprising a plurality of lighting elements that are arranged in a row to emit red, green, and blue light that are modulated according to an image to be displayed.

5. The two-dimensional optical scanning apparatus as recited in claim 4, wherein the moving body comprises:
at least two cylindrical drums; and
an endless belt or chain that is connected between the drums.

6. The two-dimensional optical scanning apparatus as recited in claim 5, wherein when the number of linear light source units is n and a length of the chain or belt is s, each linear light source unit is disposed at a distance s/n with respect to an adjacent unit on the belt or chain.

7. The two-dimensional optical scanning apparatus as recited in claim 4, wherein the apparatus has a linear section where the linear light source unit on the moving body is in rectilinear motion.

8. The two-dimensional optical scanning apparatus as recited in claim 1, wherein the linear light source unit is substantially parallel with a rotating axis of the rotating body.

9. The two-dimensional optical scanning apparatus as recited in claim 4, wherein the linear light source is substantially perpendicular to a moving direction of the moving body.

10. The two-dimensional optical scanning apparatus as recited in claim 1, further comprising a collimator lens for converting light from each lighting element of the light source unit into a substantially collimated light beam or a converging optical element for converting light from each lighting element into a converging light beam.

11. The two-dimensional optical scanning apparatus as recited in claim 4, further comprising a collimator lens for converting light from each lighting element of the light source unit into a substantially collimated light beam or a converging optical element for converting light from each lighting element into a converging light beam.

12.-14. (canceled)

15. The two-dimensional optical scanning apparatus as recited in claim 4, wherein each lighting element comprises a light emitting diode chip and an epoxy cast, the epoxy cast having a spherical or aspherical light emitting surface to function as a tens.

16. The two-dimensional optical scanning apparatus as recited in claim 1, wherein each lighting element is a light emitting diode of a surface emitter type, of which surfaces are coated by a metal film except for a predetermined area.

17. (canceled)

18. The two-dimensional optical scanning apparatus as recited in claim 1, wherein when a maximum scanning angle θₘₐₓ of the scanning unit is divided into a predetermined resolution, a time interval Δt during which the linear light source unit emits light between an i-th scanning angle θᵢ and an (i+1)-th scanning angle θᵢ₊₁ satisfies the following conditions:
tanθₘₐₓ=k(tanθᵢ−tanθᵢ₊₁) and
Δt=(θᵢ−θᵢ₊₁)/2ω,
where (2k+1) is a maximum line number of pixels;
θᵢ₊₁ is a scanning angle of an (i+1)-th line; and
ω is an angular velocity of the scanning unit.

19. The two-dimensional optical scanning apparatus as recited in claim 4,
wherein when a maximum scanning angle θₘₐₓ of the scanning unit is divided into a
predetermined resolution, a time interval Δt during which the linear light source unit
emits light between an i-th scanning angle θᵢ) and an (i+1)-th scanning angle θᵢ₊₁
satisfies the following conditions:
tanθₘₐₓ=k(tanθᵢ−tanθᵢ₊₁) and
Δt=(θᵢ−θᵢ₊₁)/2ω,
where (2k+1) is a maximum tine number of pixels;
θᵢ₊₁ is a scanning angle of an (i+1)-th line; and
ω is an angular velocity of the scanning unit.

20. An image display apparatus comprising:
a rotating body;
at least two linear light source units disposed on a surface of the rotating body, comprising a plurality of lighting elements that are arranged in a row to emit red, green, and blue light that are modulated according to an image to be displayed; and
at least one screen on which the scanned light beam is projected.

21. An image display apparatus comprising:
a moving body that rotates endlessly;
at least two linear light sources units disposed on the moving body, comprising a plurality of lighting elements that are arranged in a row to emit red, green, and blue light that are modulated according to an image to be displayed; and
at least one screen on which the scanned light beam is projected.

22. The image display apparatus as recited in claim 21, wherein the moving body comprises:
at least two cylindrical drums; and
an endless belt or chain that is connected between the drums.

23. The image display apparatus as recited in claim 21, wherein the apparatus has a linear section where the linear light source unit on the moving body is in rectilinear motion.

24. The image display apparatus as recited in claim 20, wherein the number of screens is two or more, and each screen is displaced in a different direction from each other.

25. The image display apparatus as recited in claim 21, wherein the number of screens is two or more, and each screen is arranged in a different direction from each other.
